(19) United States
(12) Patent Application Publication
(10) Pub. No.: US 2017/0249609 A1
(43) Pub. Date: Aug. 31, 2017

(54) ADVANCING PAYMENT TO AN AFFILIATE BASED ON COMPANY ELECTRONIC LINK ACTIVITY

(71) Applicant: Harsch Khandelwal, Kitchener (CA)

(72) Inventor: Harsch Khandelwal, Kitchener (CA)

(21) Appl. No.: 15/287,378

(22) Filed: Oct. 6, 2016

Related U.S. Application Data
(63) Continuation of application No. 14/615,887, filed on Feb. 6, 2015, now abandoned.
Application No. 14/615,887 is a continuation of application No. 11/588,334, filed on Oct. 27, 2006, now abandoned.
(60) Provisional application No. 60/730,389, filed on Oct. 27, 2005.

(51) Int. Cl. G06Q 20/10; G06Q 20/12; G06Q 30/02

(52) U.S. Cl. CPC G06Q 20/102; G06Q 30/0273; G06Q 20/12

(57) ABSTRACT

A method for advancing payment of a portion of one or more amounts due under an affiliate program to an affiliate, the amount being owed by a merchant of a website subject to the affiliate program. The method includes the steps of, first, providing a means for transmitting information to an administrator. The information is for use by the administrator to verify the affiliate's identity. Second, the method provides a means for enabling the administrator to verify the identity of the affiliate based on the information. Third, the method provides a means whereby the affiliate assigns the amount due under the affiliate program absolutely to the administrator, and whereby the affiliate requests that the portion of the amount due be advanced. Next, the method provides confirmation from the merchant that the amount due under the affiliate program is assigned absolutely to the administrator. Finally, the method provides a means for enabling the administrator to effect payment to the affiliate of the portion of the amount due under the affiliate program.

This application claims the benefit of U.S. Provisional Application No. 60/730,389, filed Oct. 27, 2005, in its entirety herein incorporated by reference.

### FIELD OF THE INVENTION

This invention relates to payment for affiliate programs.

### BACKGROUND OF THE INVENTION

As is known in the art, an “affiliate” is a website owner who delivers value to another website owner as specified in the terms of an associated affiliate program. Typically, the affiliate's website has a link on it. If a visitor clicks on such link, it takes the visitor to a merchant's website, at which website the visitor is offered goods and/or services. In general, the affiliate program is a contractual relationship binding upon the affiliate and the merchant (or third party affiliate tracking company—e.g. Google) which provides that the affiliate is to be paid by the merchant (or tracking company) upon the visitor taking one or more specified steps via the link in relation to the merchant's website.

Affiliates earn income based on the models described above. Typically, most affiliates promote many different affiliate programs with the same and/or different companies and keeping track of multiple payments for the different programs can be difficult. Further, there is a delay between earning the income (i.e., the date on which an amount becomes owing under the affiliate program(s)) and the affiliate receiving payment for the income earned from the company(s). For example, under one existing program, the affiliate earns income when a visitor to his or her site clicks an ad subject to this program. If this click occurs on the first day of the month, the affiliate will receive payment towards the end of the following month (i.e., almost 60 days later). Another extreme example is a second existing affiliate program which issues payment to affiliates only once every three months (i.e., once per quarter).

A further problem with current affiliate programs is that the affiliate receives payment for link interactions taken by the visitor, however this payment is typically provided separately from reporting of the manner/degree of link usage by the visitor. Accordingly, it is common that the affiliate does not know what specific visitor link interaction the payment is attributable to.

### SUMMARY OF THE INVENTION

The systems and methods disclosed herein provide for advancing payment for visitor interaction with affiliate links and to obviate or mitigate at least some of the above presented disadvantages.

Affiliates earn income based on the models described above. Typically, most affiliates promote many different affiliate programs with the same and/or different companies and keeping track of multiple payments for the different programs can be difficult. Further, there is a delay between earning the income (i.e., the date on which an amount becomes owing under the affiliate program(s)) and the affiliate receiving payment for the income earned from the company(s). A further problem with current affiliate programs is that the affiliate receives payment for link interactions taken by the visitor, however this payment is typically provided separately from reporting of the manner/degree of link usage by the visitor. Accordingly, it is common that the affiliate does not know what specific visitor link interaction the payment is attributable to. Contrary to present affiliate payment systems there is provided a method and system for communicating payment to an affiliate based on electronic link activity for directing visitor traffic over a network to a company. The link activity is attributed to the affiliate. The method and system comprise receiving a request for payment for the affiliate including a specified payment period, a specified link set, and at least one company associated with the link set; contacting the at least one company for the payment period for confirming a level of the link activity for the link set during the payment period. The system and method also comprise generating a payment for the affiliate including compensation commensurate with the confirmed level of link activity, wherein the payment is subsequently communicated to the affiliate.

According to one aspect there is provided a method for communicating payment to an affiliate based on electronic link activity for directing visitor traffic over a network to a company, the link activity being attributed to the affiliate, the method comprising the acts of: receiving a request for payment for the affiliate including a specified payment period, a specified link set, and at least one company associated with the link set; contacting the at least one company for the payment period for confirming a level of the link activity for the link set during the payment period; generating a payment for the affiliate including compensation commensurate with the confirmed level of link activity; and communicating the payment to the affiliate.

A further aspect of provided is a system for communicating payment to an affiliate based on electronic link activity for directing visitor traffic over a network to a company, the link activity being attributed to the affiliate, the system comprising: a data collection module for receiving a request for payment for the affiliate including a specified payment period, a specified link set, and at least one company associated with the link set; a confirmation module for contacting the at least one company for the payment period for confirming a level of the link activity for the link set during the payment period; and a payment module for generating a payment for the affiliate including compensation commensurate with the confirmed level of link activity; wherein the payment is communicated to the affiliate.

A still further aspect provided is a computer program product for communicating payment to an affiliate based on electronic link activity for directing visitor traffic over a network to a company, the link activity being attributed to the affiliate, the computer program product comprising: a computer readable medium; a data collection module stored on the computer readable medium for receiving a request for payment for the affiliate including a specified payment period, a specified link set, and at least one company associated with the link set; a confirmation module stored on the computer readable medium for contacting the at least one company for the payment period for confirming a level of the link activity for the link set during the payment period; and a payment module stored on the computer readable medium for generating a payment for the affiliate including compensation commensurate with the confirmed level of link activity; wherein the payment is communicated to the affiliate.

Other aspects provided are comprising receiving payment from the at least one company for at least a portion of the confirmed level of link activity after the corresponding communication of the payment to the affiliate, as well as contacting the at least one company for obtaining report information associated with the compensation included in the payment.

### BRIEF DESCRIPTION OF THE DRAWINGS

Exemplary embodiments of the invention will now be described in conjunction with the following drawings, by way of example only, in which:

FIG. 1 is a block diagram of components of an advance payment system;

FIGS. 2a,b,c,d are examples of link interaction by a visitor in the system of FIG. 1;

FIG. 3 is a further example of link interaction by a visitor in the system of FIG. 1;

FIG. 4 is a block diagram of an example computing device for implementing the components of FIG. 1;

FIG. 5 is a block diagram of the payment administration system of FIG. 1; and

FIG. 6 is a flowchart of operation of the system of FIG. 1.

### DETAILED DESCRIPTION OF THE PREFERRED EMBODIMENT(S)

### Network System 10

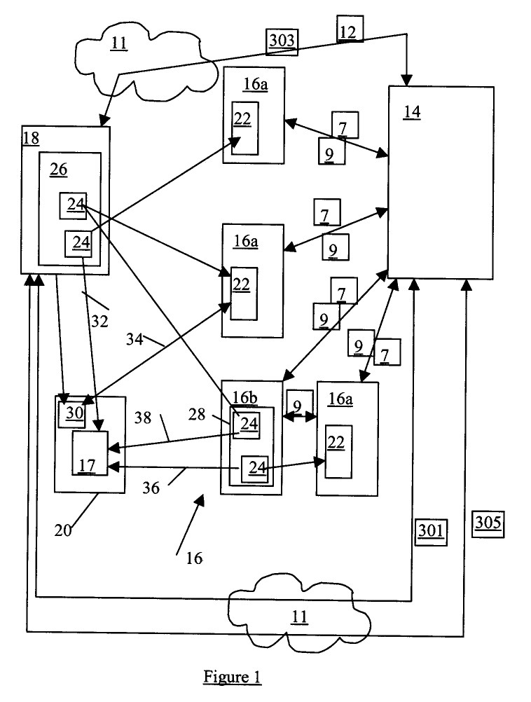

Referring to FIG. 1, shown is an advance payment system 10 for coordinating dynamically configurable payments 12 via a payment administration system 14 between a plurality of companies 16 (e.g. merchants 16a and/or third party affiliate tracking companies 16b) and at least one affiliate 18. The payments 12 are dynamically configured through a written contract (the affiliate program) between the payment administration system 14 and the respective affiliate 18, such that the companies 16 are informed to redirect to the payment administration system 14 those payments 9 which are attributable to the respective affiliate 18. The payments 12 are calculated by the payment administration system 14 and are advanced to the affiliate 18, on behalf of the companies 16, in return for visitor(s) 20 on-line traffic directed to the company websites 22 via links 24 associated with the affiliate 18. Information 7 on actual traffic/interaction (by the visitor 20) of the links 24 (for example link 24 activity including results of such interactions e.g. sales, actions, etc.) is obtained by the administration system 14 from the companies 18, in order to facilitate generation of the payments 12 as further described below. The links 24 can be positioned (e.g. hosted) on an affiliate website 26 and/or a website 28 of the third party affiliate tracking company 16b (e.g. Google), for example, further described below.

It is recognised that tracking ownership of a particular link 24 with a respective affiliate 24 can be done by methods such as but not limited to: placing a tracking cookie on the visitors 20 computing device 101 once the link 24 is interacted with (e.g. clicked); redirecting to a tracking script at the third party company 16b; and passing a tracking variable to the merchant's 16a site, for example. Further, tracking ownership of a particular link 24 can also be done using coupon/unique codes used to track commissions. For example, the affiliate 18 can provide the visitor 20 a code which the visitor then enter before checking out a purchase through the merchant 16a (e.g. at an e-Store). From the coupon code, the merchant 16b will know the sale came from the respective affiliate 18.

In one embodiment, the link 24 can be defined using hypertext. The link 24 can be referred to in general as a selectable connection from one word, picture, or information object to another. In a multimedia environment such as the Internet, such objects can include sound and motion video sequences. One example form of the link 24 is a highlighted word or picture that can be selected by the visitor 24 (with a mouse or in some other fashion), resulting in the delivery and view of another file. The highlighted object can be referred to as an anchor, such that the anchor reference and the object referred to constitute the link 24. In Hypertext Markup Language (HTML), the anchor is the establishing of a term, phrase, image, or other information object as being either: the target of the hypertext link 24 within a document, or a reference (a link 24 you can select) to such a target.

It is noted that any HTML file name can be automatically be part of the link 24 as either the anchor or target that can be linked to. For example, the anchor within the file to which one can link directly is identified by a # symbol followed by the name, such that the # is used to take the visitor 20 to a specific part of a referred page. Alternatively, the affiliate link 24 can uses URL parameters, e.g. e. www.gowlings.com?affiliate_id=HARSCH. Further, although most links do not offer the visitor 20 a choice of types of link, it would be possible for the visitor 20 to be provided a choice of link types, such as but not limited to: a definition of the object, an example of the object, a picture of the object, a smaller or larger picture of the object, etc. Further, it is recognised that hypermedia can be used to extend the meaning of the link 24 to include links 24 among any set of multimedia objects, including sound, motion video, and virtual reality, for example. Hypermedia links 24 can also connote an increased level of visitor/network interactivity than the interactivity already implicit in hypertext.

Communication between the advance payment system 10 components, i.e. the companies 16 (including websites 22,28), the affiliate administration system 14, the affiliates 18 (including the websites 26), and the visitor 20 is facilitated via one or more communication networks 11 (such as intranets and/or extranets—e.g. the Internet) using computing devices 101 further described below. The payment system 10 can include multiple visitors 20, multiple affiliates 18, one or more companies 16, one or more respective administration systems 14 and one or more coupled communication networks 11, as desired.

Referring again to FIG. 1, the affiliate program(s) (as administered by the payment administration system 14) can be a contractual relationship binding upon the affiliate(s) 18, the administration system 14, and the companies 16 (at least for instructions on where to send payments 9). The affiliate program provides that the affiliate 18 is paid through the dynamically configurable payments 12 from the administration system 14, as a result of the visitor 20 taking one or more specified steps in relation to the merchant's website 22, as initiated or otherwise coordinated by the links 24 associated with the affiliate 18. The manner in which the payments 12 are issued depends upon the defined relationship between the payment administration system 14 and the affiliate 18, as further described below. It is recognised that the companies 16 are informed that the administration system 14 is to receive corresponding payments 9 (for the affiliate 18) from the companies 16, according to the typical standard payment interval dictated by the companies 16. Further, it should be recognised that issuance timing of the payments 12 is preferably independent of receipt timing of the payments 9, as desired, for example the payments 9 are received after the payments 12 are issued.

Further, it is recognised that the administration system 14 can be used as a compensation management service by the affiliate 18, such that certain portions of compensation slated for payment 12 to the affiliate 18 (earned by the affiliate 18 through link 24 activity) may be held back by the administration system 14. In cases where the amounts are held back, it is feasible that the payments 9 for such held back amounts from the company 16 may be received by the administration system 14 before issuance of the corresponding payment 12 to the affiliate 18 has occurred. It is also recognised that the affiliate 18 may decide (as represented in data 301,305 for example) to provide for a portion (e.g. a first portion) of the link 24 activity compensation to be directly forwarded as payment 9 (from the company 16) to the affiliate 18, and the remainder portion (e.g. a second portion) of the link 24 activity compensation to be assigned to the administration system 14 and thereby received as payment 12 from the administration system 14, as further described below.

It is recognised that the payments 12 can be configured to compensate the affiliate 18 for a variety of visitor 20 interactions with the links 24, such as but not limited to: $ Per Click (CPC); $ Per thousand Impressions (CPM); and $ Per Visitor (CPV), as well as $ per sale, lead and action, for example. The visitor 20 interaction with the links 24 can be performed using communication paths over the network such as but not limited to: path 34 as performed in relation to messages 30; path 32 involving the visitor 20—affiliate 18—merchant 16a; path 36 involving the visitor 20—administration system 14—merchant 16a; and/or path 38 involving the visitor 20—affiliate 18—administration system 14 merchant 16a, in view of the link(s) 24 configuration.

Further, affiliate 18 commissions (e.g. payments 12) can be based on a fixed amount, percentage (or combination) per click, transaction, action, etc. Additionally, there are also CPM (cost per thousand) based payments where the affiliate earns a fixed fee per thousand times an action is performed (e.g., displaying a banner ad impression). In the case where the visitor 20 must perform an action (e.g., download a file) or is captured as a lead to fulfill the affiliate program's requirement for payment, the visitor 20 can perform the action or fill in the lead information either on the affiliate's website 26 or the merchant's website 22, as desired. In the latter case, the merchant 16b would have tracked that the visitor 20 came from the affiliate's 18 site through the affiliate tracking link 24, as is known in the art.

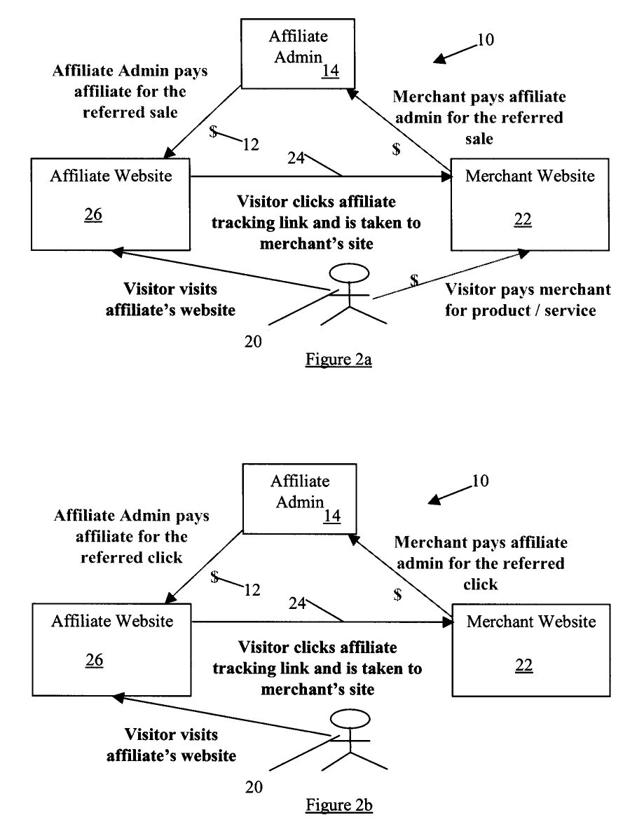

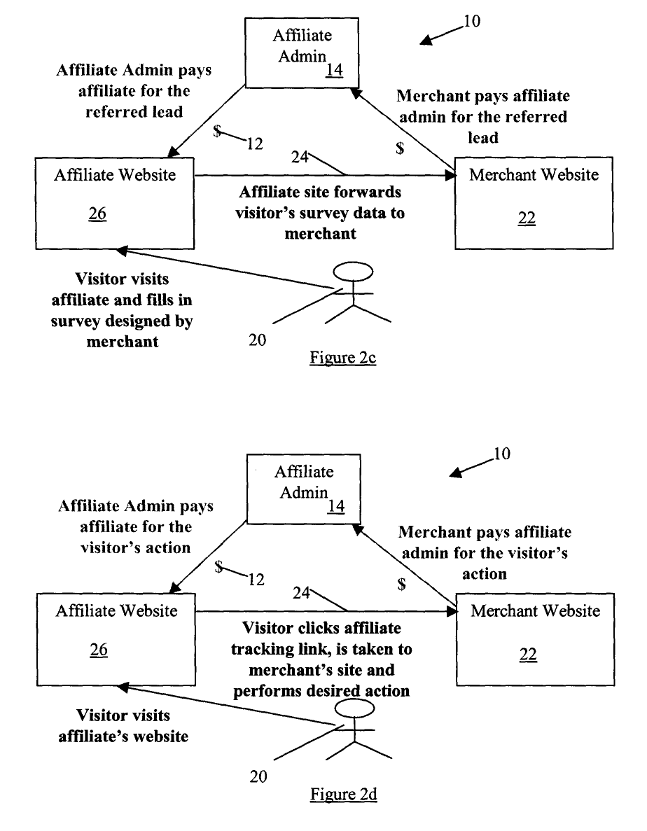

In one embodiment, the affiliate's website 26 can have the link 24 to the merchant 16a on the website 26. If the visitor 20 clicks on the link 24, the visitor 20 is redirected to the merchant's website 22, at which the visitor 20 is offered merchant 16a products (e.g. goods and/or services) for sale (see FIG. 2a). Referring to FIG. 2b, shown is an example Pay Per Click scenario between the visitor 20, affiliate 18, the affiliate admin system 14 and the merchant 16a. Referring to FIG. 2c, shown is an example Pay per Lead scenario between the visitor 20, affiliate 18, the affiliate admin system 14 and the merchant 16a. Referring to FIG. 2d, shown is an example Pay per Action (e.g. downloading trial software) scenario between the visitor 20, affiliate 18, the affiliate administration system 14 and the merchant 16a. It is recognised that the payment 12 to the affiliate 18 is preferably advanced by the payment administration system 14 to the affiliate 18 prior to receipt of merchant 16a funds 9 by the payment administration system 14, as further described below. In the cases described above, it should be recognised that the payment 12 is advanced to the affiliate 18 before corresponding payment 9 is received by the administration system 14 from the company(s) 16 in response to visitor 20 interaction with the links 24 associates with the affiliate 18.

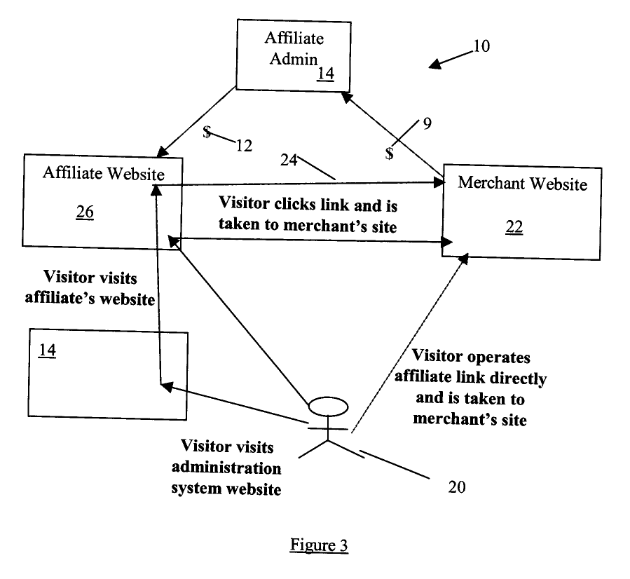

Referring to FIG. 3, in a further embodiment, the affiliate program administration (tracking clicks on affiliate links 24, managing flows of payments 9, etc.) may be performed by the third party affiliate tracking company 16b. For example, the Google's AdWords program (i.e. Google would be considered the company 16b) charges merchant 16a websites per click (or otherwise) for displaying links 24 to their sites. The Google AdSense program allows other website owners (third party webmasters such as the affiliates 18) to display these links 24 on the website 28 such that when the visitor 20 clicks on the link 24 from the third party webmaster's, Google charges the merchant 16a for the click/action of the link 24 through the AdWords program It will be understood that the third party webmaster (e.g. affiliate 18) can be referred to as an agent for the merchant 16a. It is recognised that the system 10 shown in FIG. 3 can be used to implement all examples shown in FIGS. 2a,b,c,d as well as others as desired.

A further embodiment of the company 16b is Commission Junction (www.cj.com) as an example of a third party affiliate management company. Commission Junction runs affiliate programs for several websites, such that affiliates 18 can create profiles with Commission Junction and can participate in affiliate programs for the merchants 16b Commission Junction manages programs for.

Referring again to FIG. 1, the affiliate 18 can be a website 26 owner, and/or other electronics communication-based advertiser communicating electronic emails/messages to visitors 20 with included links 24, who delivers value to another website 22,28 owner (e.g. company 16) as specified in the terms of the affiliate program (e.g. a written contract). For example, Affiliate 18 marketing can be defined as use by a Web 26 site that sells products of other Web 22 sites to help market the products, e.g. Amazon.com, the book seller, created a large-scale affiliate program. The company 16 can be a merchant 16b, also known as an advertiser or retailer, that has/hosts the web site 22 that sells a product online, accepts payments and fulfills orders. Merchants 16a acquire new customers and pay affiliates 18 only when a sale or other qualifying action is completed. This is called CPA or performance-based marketing. The company 16 can also be a trusted third-party 16b (e.g. LinkShare, Google, Yahoo, etc.) that brings together both merchants 16a and the affiliates 18. The trusted third-party 16b can perform additional services such as tracking and reporting on every ad or placement in the network 10, send monthly (or other delayed time period) payments to the affiliate administration systems 14, and provide services and tools that help merchants 16b and affiliates 18 optimize their performance, as desired.

The affiliates 18 (also called publishers) can make merchants' ads containing links 24, text links 24, and/or product links 24, for example, available to the visitors 20 using a variety of methods including such as but not limited to: on their websites 26; through using shopping engines or other search engines (e.g. third party affiliate tracking companies 14 such as Google and Yahoo); in blogs; in electronic e-mail/message 30 campaigns sent to the visitor 20; and in electronically accessible search listings (not shown). The affiliate 18 makes these links 24 available to the visitor 20 in exchange for commissions (i.e. payments 12) on leads, sales, and/or general interest shown by the visitor 20 in company 16 products via usage of the links 24. It is recognised that the links 24 can include link mechanisms such as but not limited to: Inline Text Links; Text Banners; Graphical/Rich Media Banners; In-page Graphical Banner; PopUnders/Ups; XML Feeds; Layer Ads; and Search box, for example.

In economics, economic output is divided into goods and services. When an economic activity yields a valuable or useful thing, it can be known as production output of the totality of products (e.g. goods or services) in an economy that the company 16 makes available for use by the visitors 20. Products as goods can range from a simple safety pin, food, clothing, computer components to complex aircraft. Products as services are the performance of any duties or work for another (e.g. helpful or professional activity) and can be used to define intangible specialized economic activities such as but not limited to: providing access to specific information; web services; transport; banking; legal advice; accounting advice; management consultant advice; and medical services. The company 16 providing the products can be a businessperson/individual engaged in wholesale/retail trade, an organization, an administration, and/or a business that sells, administers, maintains, charges for or otherwise makes available product(s) that are desirable by the visitors 20. Accordingly, the company 16 can be one person, or an association of persons, for the purpose of carrying on some enterprise or business; a corporation; a firm; etc. Further, it is recognised that the use of the links 24 can be applied to direct the visitor 20 to company 16 activities not related to specific product(s), for example customer service, community activities, and/or sponsorships. These general activities of the company 16 are also considered as part of the definition of company 16 products.

### Computing Devices 101

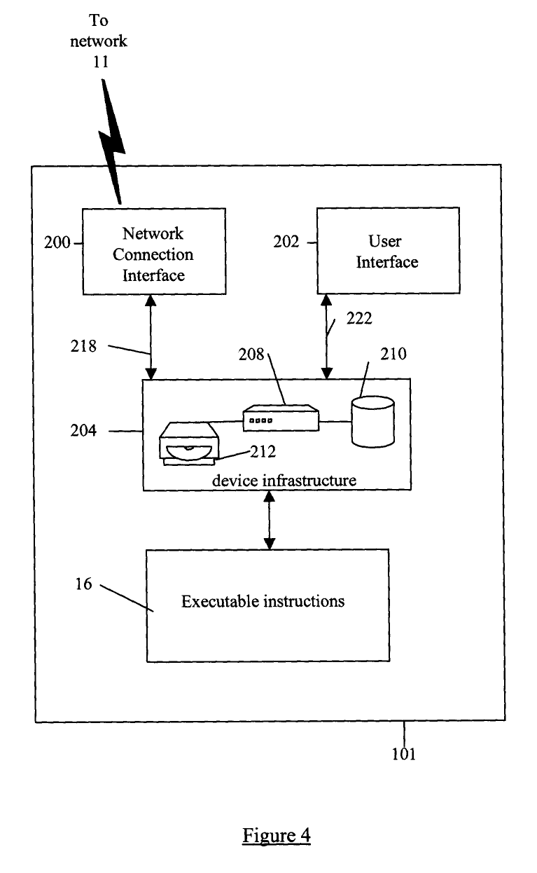

Referring to FIGS. 1 and 4, each of the above-described components of the payment system 10, i.e. visitors 20, affiliates 18, companies 16, and administration systems, can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 11 (e.g. an intranet and/or an extranet such as the Internet), which enables the devices 101 to communicate with each other as appropriate. The network 11 can support the payment 12 between the administration system 14 and the affiliates 18, as well as facilitating operation of the links 24 between the visitor and ultimately the companies 16 (e.g. merchants 16a).

Referring again to FIG. 2, the devices 101 can also have a user interface 202, coupled to the device infrastructure 204 by connection 222, to interact with a user (e.g. company 16, visitor 20, affiliate 18, administration system 14, etc.). The user interface 202 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the visitors 20 can be configured to interact with a visitors' 20 web browsers (applications 17) to access the links 24 via websites 26 of the affiliates 18, as well as to access the products (and/or information pertaining thereto) available on the company websites 22. For the devices 101 used by the affiliates 18, the user interfaces 202 can be used to access the administration system 14 to provide the sign-up data 301, payment data 305, and to access report data 303, as further described below.

Referring again to FIG. 2, operation of the device 101 is facilitated by the device infrastructure 204. The device infrastructure 204 includes one or more computer processors 208 and can include an associated memory 210 (e.g. a random access memory). The computer processor 208 facilitates performance of the device 101 configured for the intended task (e.g. visitor 20, affiliate 18, company 16, administration system 14) through operation of the network interface 200, the user interface 202 and other application programs/hardware of the device 101 by executing task related instructions, These task related instructions can be provided by an operating system, and/or software applications 17 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client applications 16. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid state memory card, or RAM provided in the memory module 210. It should be noted that the above listed example computer readable mediums 212 can be used either alone or in combination.

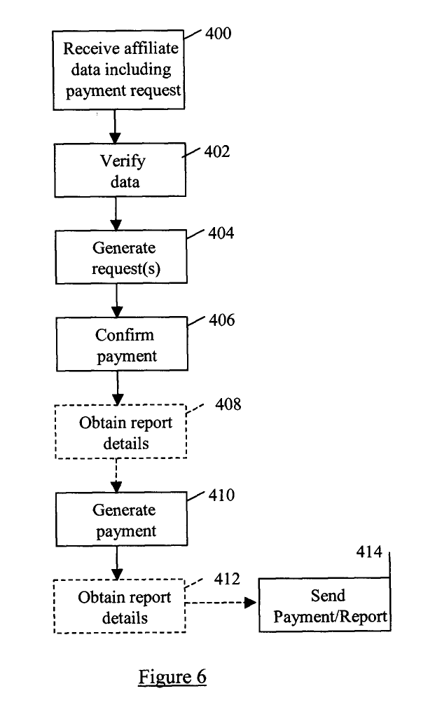

Further, it is recognized that the computing devices 101 can include the executable applications 17 comprising code or machine readable instructions for implementing predetermined functions/operations including those of an operating system, a web browser, the data 7,301,305,303 collection/processing, payment 9,12 collection/processing, and link 24 operation, for example, in response user command/input and/or predefined link 24 configuration as is know in the art. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality (e.g. modules 300, 304, 306, 307, 310, 312, 314) provided by the systems and process of FIGS. 1 and 6 may be implemented in hardware, software or a combination of both. Accordingly, the use of a processor 208 as a device and/or as a set of machine readable instructions is hereafter referred to generically as a processor/module for sake of simplicity. Further, it is recognised that the administration system 14 can include one or more of the computing devices 101 (comprising hardware and/or softWare) for implementing the modules 300, 304, 306, 307, 310, 312, 314 as desired.

It will be understood that the visitor 20 client computing devices 101 may be, for example, personal computers, personal digital assistants, mobile phones, and content players. Server computing devices 101 (e.g. for the administration system 14 and/or the companies 24 and affiliates 18) may additionally include a secondary storage element such as the memory 308 (e.g. database). Each server, although depicted as a single computer system, may be implemented as a network of computer processors, as desired.

Further, it will be understood that for the purposes hereof, the visitor 20 may be any user (i.e. first hand product experience), or acquaintance of any visitor 20 (i.e. second hand product experience), of company 24 products (e.g. goods and/or services) to which the links 24 will be directed to. For example, the visitor 20 may be an individual who purchases goods and/or services for personal use, and not for resale or for use in the production of other goods and/or services for resale. Or the visitor 20 may be a business purchasing good and/or services for use in its business, i.e., for resale or for use in the production of other goods and/or services for resale. Further, it is recognised that visitor 20 may not have purchased the goods and/or services. For example, the visitor 20 may have acquired the goods and/or services pursuant to a free trial offered by the website owner (e.g. company 16). The link 24 basis on which the visitor 20 acquired/accessed the goods and/or services can be useful information for providing to the administrator system 14 in the data 301. Further, the data 7, 301,305 received by the data collection module 300 is preferably included as part of the confirmation/verification process provided by the verification module 304, described further below.

### Payment Administration System 14

Referring to FIGS. 1 and 6, the payment administration system 14 has a data collection module 300 for receiving a request to enrol the affiliate 18 as a client of the system 14 prepayment services. As part of the request the affiliate 18 submits enrolment data 301, which can include identification data for the affiliate 18 (e.g. website 26 UAL), payment configuration information on the how the payments 12 are to be configured (e.g. amounts, link 24 types, payment 12 frequency, and corresponding company(s) 16 contracted for paying for the affiliate services provided through, the links 24), and optionally content and format data 305 of reports 303 detailing the affiliate 18 services paid for through each respective payment 12 received from the payment administration system 14, as further described below The received enrolment/configuration data 301 and optional report configuration data 305 are confirmed by a verification module 304, as to the authenticity of the data 301. Once verified, the data 301,305 can be stored in the database 308 for subsequent use by a payment module 306 for generating the payment 12 and a status module 307 for generating the optional report 303 if so configured, as further described below.

Further, once the data 301,305 has been verified, the verification module 304 provides the affiliate 18 with a user ID and password (optional), which uniquely identifies a payment service account 40 that the affiliate 18 now has with the payment administration system 14. It is recognised that the affiliate 18 (and/or the administration system 14) shares the issued user ID of the affiliate 18 with the company(s) 16 in order to facilitate receipt, processing, and assignment of the received payments 9 to the correct affiliate 18, a well as to facilitate a receivables management module 310 to identify the correct affiliate 18 and link 24 activity from the company(s) 16, as further described below.

All accounts 40 for respective affiliates 18 along with their data 301,305 can be stored in an account table 42 in the memory 308, which is used by the payment module 306 and/or the status module 307 for submitting a respective payment 44 and/or report 46 request to a queue 309, for subsequent use by the receivables management module 310. The queue 309 can be used to facilitate scheduling of the requests 44,46 (according to the payment 12 frequency defined in the data 301), which are communicated to the company 16 in order to determine if link 24 activity for the respective company 16 justifies generation and transmission of corresponding payment(s) 12 to the affiliate 18. For example, the receivables management module 310 determines from the company(s) 16 of any link 24 activity associated with the affiliate 18 that the company(s) 16 state have occurred since the date of the previous payment 12 sent to the affiliate 18. Accordingly, compensation for these new link 24 activities is included in the new payment 12, as well as any optional reports 303 detailing link 24 information associated with the new payment 12, as further described below. It is also recognised that the module 310 can also generate the requests 44,46 for sending to the company 16 directly from the data 301,305 and then inform the modules 306,307 of the response from the company(s) 16, as an alternative embodiment.

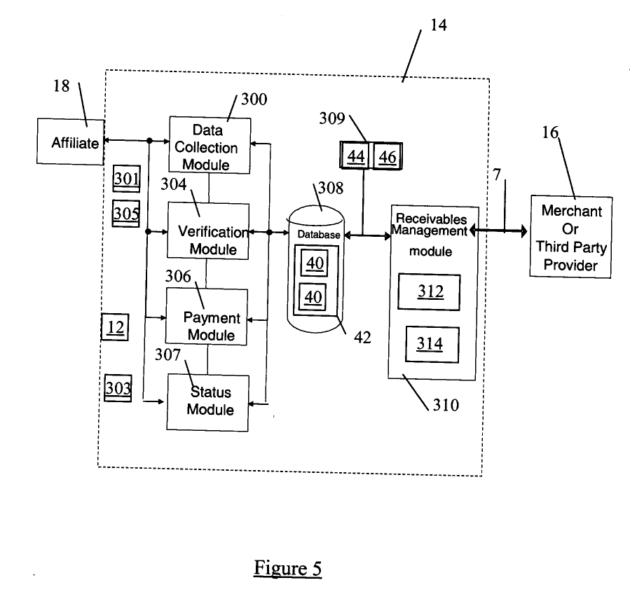

Referring again to FIG. 5, the administration system 14 also has the receivables management module 310 for confirming via information 7 exchange with the company(s) 16, as to whether/how the scheduled payment 12 and optional report 303 should be generated, as well as what the content should be for such scheduled payment 12 and optional report 303. The receivables management module 310 facilitates generation of the payments 12 to each affiliate 18 according to the payment 12 frequencies specified via the queue 309. The receivables management module 310 sends the requests 44,46 from the queue 309 (for example or by other scheduling techniques based on the defined payment 12 frequency of the data 301,305) to the companies 16 specified by the affiliate 18 in order to determine if link 24 activity attributable to the affiliate 18 justifies the scheduled new payment 12, as further described below.

Further, the receivables management module 310 also obtains via information 7 details (in response to the requests 44,46) of the link 24 activity identified by the company 16 for determining what specific link 24 activities the payment 12 corresponds with, from which the report 303 can be generated. It is recognised that the receivables management module 310 can also request additional link 24 activity details from the companies 16 as required by the data 301,305, in addition to what is contained in the requests 44,46. If the company(s) 16 acknowledge that there are sufficient link 24 activities, to date, to warrant generation and transmission of the next payment 12 (or portion thereof) to the affiliate 18, then the payment module 306 provides for the generation and submission of the payment 12 including suitable compensation (as well as optional report 303 if so configured) to the affiliate 18 over the network 11.

### Data Collection Module 300

Referring again to FIG. 5, the administration system 14 is operated and managed by an administrator (not shown). The affiliate 18 initiates use of the prepayment services of the payment administration system 14 by supplying enrolment data 301 to the collection module 300. The data collection module 300 is configured to receive the enrolment data 301 from the affiliate 18 in order to set-up the affiliate 18 for desired dynamically configured payment 12 from the administration system 14 for link 24 interaction by the visitor 20. The data collection module 300 receives a request to enrol the affiliate 18 as a client of the system 14 prepayment services. As part of the request the affiliate 18 submits enrolment data 301, which can include identification data for the affiliate 18 (e.g. website 26 URL), payment configuration information on the how the payments 12 are to be configured (e.g. amounts, link 24 types, payment 12 frequency, and corresponding company(s) 16 contracted for paying for the affiliate services provided through the links 24), and optionally content and format data 305 of reports 303 detailing the affiliate 18 services paid for through each respective payment 12 received from the payment administration system 14. It is recognised that the payment 12 can be a recurring (i.e. repeated scheduling for the specified frequency) payment 12 or a one time payment 12, as defined by the data 301. Further, the affiliate 18 can change the account 40 status (or portions thereof), including such as but not limited to; pause, delete, or resume the accounts 40 (or portion thereof) at any time, as well as specifying a percentage of amounts due in view of the link 24 activity instead of actual total dollar amounts associated with the link 24 activity (e.g. the link 24 activity and associated compensation as confirmed by the receivables management module 310).

It is recognised that providing the data 301 over the network 11 can include communication such as but not limited to: voice communication via phone; written communication (with or without included audio and/or image components) via network messaging (e.g. email, facsimile); and/or others as desired.

In one embodiment, the enrolment data 301 can come from the affiliate 18 operating as the website 26 owner. The affiliate 18 uses the affiliate 18 computing device 101, for example, to submit affiliate 18 and Website 26 information. The affiliate 18 information can include information such as but not limited to: affiliate 18 name phone number; affiliate 18 facsimile number; physical address; email address; identification information for the companies 16 used by the affiliate 18 (e.g. company 16 URL, address, and other communication/contact information); and other affiliate 18 materials (e.g. link 24 information including link 24 categories/types and associated affiliate 18 promotional campaign). For example, a merchant 16b can have multiple promotional campaigns going on each with their own links 24 and compensation structures) and/or link 24 compensation information (the affiliate 18 gets paid as compensation associated with the use of that link).

Further, the enrolment data 301 can include which class(es) of links 24 are being provided to the visitor 20 as well as the company 16 products attributed to (e.g. customer service, product/service, and product category (e.g. children's toy, personal use, business use, service as compared to goods, etc.). In addition, the data 301 can contain link 24 information on specific keywords, ad texts, ad images, URLs, company accounts, campaigns (e.g. group of ads for selected companies 16), and/or ad groups (e.g. for any company 16), among others link classifications/categories. Further, the data 301 can contain cost/compensation metrics for the various link 24 types in general or on a company 16 by company 16 basis. For example, these metrics can include agreed upon compensation (by the company 16) for such as but not limited to: Clicks, Impressions (Impr.); sales; leads; actions; etc. It is recognised that the affiliate 18 may also provide (or have provided by the company 16 on behalf of the affiliate 18) data 301,305 further including merchant tracked information such as but not limited to:Clickthrough Rate (CTR), Average CPC (Avg. CPC) or Average CPM (Avg. CPM, for site-targeted ads), Cost, Average Position (Avg. Posy, and/or Maximum CPC or Maximum CPM settings. It is recognised that the affiliate 18 may be interested in CTR to see if it's worth promoting that particular program and the affiliate 18 may be paid on a CPM or CPC basis in addition to a variety of ways, e.g. 10% of each sale, $20 per lead, $1 per download, etc. It is also recognised that the Avg Position, Max CPC etc can be set by the merchants 16a and the Avg Pos. is reported to the merchants 16a to show where the ads (associated with the links 24) they are paying for showed up.

It is understood that Clicks can define the link 24 clicks accrued for the relevant campaign/group, the Impressions can define the link 24 number of times an ad is visited by the visitor 20, Clickthrough Rate can define the link 24 Clickthrough rate (CTR) as the number of clicks by the visitors 20 an ad receives divided by the number of times the ad is shown (impressions), Average CPC can define the link 24 default keyword matching option as broad matching (unless keywords targeted as exact matches, the ad shows for all variations of the keyword up to the maximum CPC amount), Average CPM can define the link 24 for advertisers who choose to run cost-per-impression advertising showing the typical cost per 1000 impressions (or other denomination as desired), and Cost can define the link 24 actual cost accrued for clicks on the link 24 (e.g. ad).

In addition, the data'301 can define frequency of payment 12 based on defined dynamically configurable Time Periods, e.g. specified date ranges and/or time ranges, (for the account 40 in total or as different frequencies for selected links 24 and/or link 24 combinations) such as but not limited to: yesterday; today; last 7 days (or other day grouping), current to date this month, and/or any other date range/time period specified by the affiliate 18. Further, it is recognised that the payment 12 frequency(s) can be dynamically updated by the affiliate 18 upon request to the administration system 14 once the account 40 has been established (e.g. the affiliate would use the issued user ID and password to request the account 40 changes, as desired). It should be recognised that the dynamic configuration and subsequent receipt of the payments 12 is not dependent upon receipt of the payments 9 by the administration system 14.

Further, the enrolment data 301 can include the Website 26 information such as but not limited to: the Website's URL(s) (uniform resource locator, also known as universal resource locator); other affiliate URL(s); the Website 26 name; and personal contact information (name, phone, email, address) for the Website 26. Preferably, the enrolment data 301 is transmitted to (or otherwise requested from) the data collection module 300 over the network 11. Further, the enrolment data 301 can also include a copy of a written contract with terms on which the affiliate 18 is to provide the links 24 to the visitor 20 as well as payment terms therefore. The data 301 can also include reassignment permission such that the affiliate 18 agrees to transfer receipt of the company payments 9 (all or a portion of the compensation related to link 24 activity specified in the data 301, 305) from the affiliate 18 to the administration system 14.

Further, it is recognised that the communication over the network 11 of the data 7,301,305 can include communication such as but not limited to: voice communication via phone; written communication (with or without included audio/video and image components) via network messaging (e.g. email, facsimile); and/or others as desired. In particular, voice communication over phone can include an IVR (short for interactive voice response) system, for example, in which the affiliate 18 uses a touch-tone telephone (and/or possibly using voice activated commands) to interact with the administration system 14 (and for example the database 308) to provide the data 7, 301, 305. It is recognised that IVR technology may not require human interaction over the telephone as the affiliate's 18 interaction with the administration system 14 would be predetermined by what the IVR system would allow the affiliate 18 access to. For example, the IVR can be used to prompt the affiliate 18 to answer questions by pushing the numbers on a touch-tone telephone or directly saying responses (e.g. computing device 101) connected via the network 11 to the administration system 14.

### Verification Module 304

Referring again to FIG. 5, the administration system 14 also has the verification module 304 for verifying the data 301,305 received via the data collection module 300, such that any of the verified data 301,305 has the potential for use in generating the payment 12, the report 303, as well as being included in the requests 44,46 as information 7 communicated between the administration system 14 and the company(s) 16. This verification process as implemented by the verification module 304 can include electronically (e.g. via the network 11) or otherwise contacting and confirming the affiliate 18 specified to confirm the validity of the data 301, 305 as well as to contact the company(s) 16 to confirm the validity of the data 301, 305. The verification process can include manual and/or automatic verification methods, as desired.

The verification module 304 can confirm the authenticity of the data 301,305 by methods including such as but not limited to: issuing a confirmation email to an address associated with the affiliate 18 (e.g. website's 26 domain) and/or checking the address data against an affiliate 18 database directory or series of directories (e.g. third party supplied—not shown) available via the connected network 11. One example of the affiliate 18 directory could be a affiliate 18 listing available on-line that provides affiliate 18 address, contact, and other company details. Further, the verification module 304 may facilitate verification of a telephone number provided by the affiliate 18 by telephoning the telephone number. Or, to confirm an address, the affiliate 18 may provide (or be prompted to provide) a copy of a utility bill for its premises, e.g., by facsimile transmission or otherwise, or other suitable documentation showing proof of affiliate 18 address as specified in the data 301,305. It is recognised that the data 301,305 verification can be done automatically and/or manually (by a user of the administration system computing device 101), as facilitated by the verification module 304. Details of the verification process concerning the data 301,305 can be stored in the memory 308, as desired. Further, the verification module can confirm details of the links 24 and company(s) 16 by contacting the company(s) 16, for example using the methods described above.

Further, the phone/voice verification for the data 301,305 can be done manually or via an automated service. For example, the affiliate 18 can enter their phone number and the verification module 304 would implement a call to the affiliate 18 (for example during the same session between the affiliate 18 and the administration system 14). The administration system 14 would then provide a unique identifier (e.g. a PIN number) which the affiliate 18 then says/enters when they take the call. The verification module 304 can also facilitate recording of the conversation with the affiliate 18, and/or whether the conversation was manually conducted or not, and store in the memory 308 for further verification proof of the data 301,305.

For example, once collected, the data 301,305 is verified by the verification module 304 which may, for example, check database resources connected by networks 11 for validity of the information. It will be understood that in addition to the steps taken by the verification module 304, a number of other steps may be taken to verify information provided by the affiliate 18. For example, the verification module 304 may verify a telephone number provided by the affiliate 18 by telephoning the telephone number. Also, to confirm an address, the affiliate 18 may provide a copy of a utility bill for its premises, e.g., by facsimile transmission or otherwise. As another example, the verification module 304 may send an e-mail message to an e-mail address provided by the affiliate 18, requesting confirmation that the e-mail address is correct.

After verification, the affiliate 18 assigns the accounts receivable owed to the affiliate 18 (e.g. payments 9) by the companies 16 to the administration system 14. This can require, for example, that the affiliate 18 execute and deliver, to the administration system 14, an assignment in a document (the agreement) which is satisfactory to the administration system 14 and to the affiliate 18 (and/or company 16 as needed).

Preferably, the agreement is first provided to the affiliate 18 electronically by the administration system 14, i.e., after verification of the data 301,305 provided by the affiliate 18 as described by example above. The agreement may be executed and delivered by the affiliate 18 via any suitable mechanism, e.g., it may be a “click-wrap” electronic document delivered over the network 11. According, for example, once the administrator's agreement has been executed and delivered by the affiliate 18, the affiliate 18 requests that affiliate earnings be forwarded (advanced) as payment 12 prior to the payment 9 date specified by the relevant company 16.

It will be understood that the agreement may contain a number of provisions addressing issues in addition to the assignment of accounts receivable in favor of the administration system 14. For example, the assignment under the agreement can be an absolute assignment of the entire/partial amount due under any company(s) 16 affiliate programs for a predetermined time period. For example, the assignment may be an assignment of all/partial amounts due to the affiliate 18 over a calendar month, a calendar year, or any other specified time period or date range from one or more companies 16, as desired. Alternatively, the assignment may function as an assignment of all/partial amounts due to the affiliate 18 under the company(s) 16 affiliate program in the near future, i.e., until the assignee assigns the amounts due back to the affiliate 18.

In an alternate mode of operation, the request for assignment of the receivables (e.g. payments 9) could be sent by the affiliate 18 directly to the company 16. The company 16 would then submit the confirmation of successful assignment (preferably, including a copy of an administrator's agreement, as executed by the affiliate 18) along with the affiliate's 18 verified personal details required for payment 12 to the receivables management module 310 (or the data collection module 300) over the network 11, as desired. The confirmation of the successful assignment would include such details as may be required by the administration system 14, including the user ID(s) issued by the company 16 for example. Once such confirmation is received, the payment module 306 will issue payment 12 and the status module 307 will issue the report 303 as outlined earlier in response to one time and/or scheduled requests 44,46.

It is also considered that implementation of the modules 300,304 could be combined as a common interactive interlace provided to the affiliate 18 and/or company(s) 16 as desired.

### Payment Module 306

The payment module 306 provides for generation of billing and collection of amounts owed to the affiliate 18, in view of the degree of link 24 activity by the visitor(s) 20. The data associated with the billing process (e.g. billing amounts, company account status, etc.) can be stored in the memory 308, as desired. It is recognised that the payment 12 can include income earned by the affiliate 18 (through link 24 activity) as consolidated from multiple campaigns with one or more companies 16.

The payment module 306 generates all payments 12 for respective affiliates 18 that have been approved/confirmed by the receivables management module 310. The payment module 306 uses the data 301,305 for a respective account 40 to submit a respective payment 44 request to the queue 309, for subsequent use by the receivables management module 310. The queue 309 can be used to facilitate scheduling of the requests 44,46 (according to the payment 12 frequency defined in the data 301). The receivables management module 310 confirms the request 44 (or denies such) and the payment module 306 generates the corresponding payment 12 (including all, a portion, or none) of the compensation as agreed upon between the administration system 14 and the affiliate 18.

For example, the payment module 306 issues payment 12 of a portion/percentage of any payment 9 amounts now due to the administration system 14 on behalf of the affiliate 18, by methods including but not limited to wire transfer, cheque or online money transfer systems over the network 11. The amount paid will be the amount ultimately due from the company 16 (via payment 9) minus an appropriate fee (fixed, commission based or combination thereof) i.e., the balance after deduction of the fee is the portion paid to the affiliate 18 by the administration system 14. Preferably, such payment 12 to the affiliate 18 should be prompt and sent before, receipt of the corresponding payment 9 by the administration system 14.

Further, for example, if the response to the request 44 from the company 16 indicates that the assignment could not be successfully completed (along with the reason—i.e. insufficient link 24 activity for the period specified), the affiliate 18 will be issued a message (in the form of the non or partial payment 12—electronically delivered or otherwise) informing the affiliate 18 that the transaction was unsuccessful, and advising the affiliate 18 of the reasons provided by the company 16. Accordingly, the request(s) 44 are communicated to the company(s) 16 in order to determine if link 24 activity for the respective company(s) 16 justifies generation and transmission of corresponding payment(s) 12 to the affiliate 18.

Further, it is recognised that the administration system 14 could forward the full amount (or agreed upon percentage portion of the full amount) earned by the affiliate 18 as payments 12 in exchange for a generic subscription paid to the administration system 14. For example, in exchange for a monthly/yearly (or other time period) subscription payment by the affiliate 18 to the administration system 14, the administration system would send the full compensation (as confirmed via the company 16 link activity 24 records) to the affiliate 18 in the payment(s) 12.

Further, it is recognised that the payment 12 can include additional information such as but not limited to: a receipt of account charges; the payment subtotal; method of payment; and date and time of the payment transaction. In the event of full or partial payment 12 decline, the payment 12 can include itemized payment declination information and the reason the billing system was unable to process the payment(s) 12 as specified in the data 301, 305.

### Status Module 307

The status module 307 optionally generates the report 303 for sending to the affiliate 18 in association with the payment 12. the report can be used by the affiliate 18 to reconcile their accounts receivable in order to match the dollar amounts in the payment 12 with the corresponding link 24 activity experienced by the respective companies 16. The status module 307 submitting a respective report 46 request to the queue 309, for subsequent use by the receivables management module 310. The queue 309 can be used to facilitate scheduling of the requests 46 (according to the payment 12 frequency defined in the data 301), which are communicated to the company 16 in order to determine if/how link 24 activity for the respective company 16 justifies generation and transmission of corresponding payment(s) 12 to the affiliate 18. Accordingly, the optional reports 303 detailing link 24 information associated with the new payment 12 is generated based on feedback received by the receivables management module 310 in response to the request 46.

The report 303 can contain link 24 activity information such as but not limited to: the status of the links 24 (e.g. ads) and account 40 information in general; date ranges and the level of reporting detail for the payment 12; payment 12 history and pending charges; and/or account 40 settings. Further, the report 303 could contain link 24 activity information detailing the percentage portion of the total compensation (earned by the affiliate 18) included in the payment 12, as well as what the remaining portion amount is. Further, the report could include details as to when the remaining portion amount could be expected by the affiliate 18, either in future payments 12 and/or as a payment 9 directly from the company 16 according to the company 16 static payment schedule.

Further, the report 303 can include can contain link 24 compensation information on specific keywords, ad texts, ad images, URLs, company accounts, campaigns (e.g. group of ads for selected companies 16), and/or ad groups (e.g. for any company 16), total account 40, among other link 24 classifications/categories. Further, the report 303 can contain compensation metrics for the various link 24 types in general or on a company 16 by company 16 basis. For example, these compensation metrics can include agreed upon compensation (by the company 16 or groups of companies 16 and/or by link 24 type for example) for such as but not limited to: [Clicks, Impressions (Impr.), Clickthrough Rate (CTR), Average CPC (Avg. CPC) or Average CPM (Avg. CPM, for site-targeted ads), Cost, Average Position (Avg. Pas), and/or Maximum CPC or Maximum CPM settings.

Further the report 303 can include such as but not limited to: performance data for the links 24 for all companies 16 or those in selected campaigns; data and ad text for each ad/group; for each image ad; each destination URL (e.g. of company 16), entire account 40; and/or for selected campaigns, as desired.

Further, it is recognised that the report 303 can include: invoice details such as Invoice/payment date and time; applicable taxes; invoice number and user ID; payment terms (immediate charge or credit line); and all line items associated with your payment; account 40 adjustments and fees such as applicable fees (account activation or re-activation), administration system 14 service charges, and billing adjustments reflecting promotional credits; credits for invalid link 24 activity toward your account 40; advertising charges by campaign including relevant campaign(s) for which activity was recorded; date range including corresponding dates for activity accrued per campaign(s); billable activity including explanation of charges (e.g. Clicks, Impressions, sales, actions, or Overdelivery credit); number of clicks or impressions, actions, sales; number of clicks or impressions, actions, sales accrued; the daily (or otherwise) total for the relevant campaign(s) for the delivery period shown; compensation accrued during the delivery period shown; and any combination of the above.

It is recognised that the report 303, or portions thereof, could be sent as a separate report 303 or included in the payment 12, as desired.

### Receivables Management Module 310

Referring again to FIG. 5, the receivables management module 310 facilitates collection of the information 7 on actual traffic/interaction (by the visitor 20) of the links 24, in order to approve/confirm the generation of the scheduled payment 12, and optionally the report 303. The receivables management module 310 approves whether/how the scheduled payment 12 and optional report 303 should be generated, as well as what the content should be for such scheduled payment 12 and optional report 303. The receivables management module 310 facilitates generation of the payments 12 to each affiliate 18 according to the payment 12 frequencies specified via the queue 309. The receivables management module 310 sends the requests 44,46 from the queue 309 (for example or by other scheduling techniques based on the defined payment 12 frequency of the data 301,305) to the companies 16 specified by the affiliate 18 in order to determine if link 24 activity attributable to the affiliate 18 justifies the scheduled new payment 12.

The information 7 collected from the companies 16 in view of the requests 44,46 can be as described above with respect to the information (e.g. specific links 24, campaigns, ad groups, etc.) used by the status module 307 and the payment module 306, or any subset thereof, as desired. It is recognised that the receivables management module 310 can also request additional link 24 activity details from the companies 16 as required by the data 301,305, in addition to what is contained in the requests 44,46. If the company(s) 16 acknowledge that there are sufficient link 24 activities, to date, to warrant generation and transmission of the next payment 12 (or portion thereof) to the affiliate 18, then the receivables management module 310 confirms or otherwise makes available to the modules 306, 307 information required for the generation and submission of the payment 12 including suitable compensation (as well as optional report 303 if so configured) to the affiliate 18 over the network 11.

Accordingly, the receivables management module 310 checks with the company(s) 16 to confirm the amount of compensation that the affiliate 18 has earned over the payment period specified in the request 44, i.e. though link 24 activity with the visitor(s) 20. Further, it is recognised that the payment 12 can contain compensation less that the amount (e.g. total or percent of the total) expected from the administration system 14 by the affiliate 18 for the specified time period (as agreed via the data 301 with respect to the scheduled payments 12 (amount/frequency) to be forwarded to the affiliate 18 by the administration system 14, for example).

In any event, it is recognised that the company 16 sends the full amount owed to the administration system 14 (as assigned to the administration system 14 by the affiliate 18) and the administration system 14 determines (e.g. via the written contract with the affiliate 18) how the earned compensation is to be distributed to the affiliate 18 (e.g. by amount, frequency, etc.), for example irrespective of the payment 9 when received by the administration system 14.

For example, the receivables management module 310 can have a confirmation module 312 for facilitating communication with the company(s) 16 of the request(s) 46 (e.g. desired report 303 information) and the response thereto, as well as a receivables module 314 for facilitating communication with the company(s) 16 of the request(s) 44 (e.g. desired earned compensation information based on link 24 activity) and the response thereto.

Further, it is recognised that the receivables management module 310 can also confirm the earned compensation of the affiliate(s) 18 via the table 42 of the affiliate accounts 40. In this case, the receivables management module 310 can confirm the request 44 of the payment module 306 (for example), through the stored account 40 profile of the particular affiliate 18, such that the forwarding of the compensation in the scheduled payment 12 is done prior to confirmation via the company records 16 that the compensation has been fully earned via actual link 24 activity (as compared to theoretical). This type of account 40 confirmation can be done in lieu of, or in addition to, any confirmation received from the company 16 pertaining to the link 24 activity (e.g. a courtesy for affiliates 18 with a long history of stable earnings).

### Operation of the System 10

Referring to FIG. 6, shown is an example operation of the system 10 for communicating the payment 12 to the affiliate 18 based on electronic link 24 activity for directing visitor 20 traffic over the network 11 to the company 16, the link 24 activity being attributed to the affiliate 18. At step 400 the data collection module 300 receives a request for payment (e.g. data 310,305) for the affiliate 18 including a specified payment period, a specified link set, and at least one company 16 associated with the link 24 set. At step 402, the verification module 304 verifies the request for payment and sets up the affiliate account 40. At step 404 the payment request 44 by the payment module 306, for example, (and optional status request 46 by the status module 307, for example) is/are generated for use by the receivables management module 310. At step 406, the confirmation module 312 contacts the company(s) 16 (and/or searches the affiliate accounts 40 profiles) for the payment period for confirming a level of the link 24 activity for the link set during the payment period. At step 408, optionally the report module 314 contacts the company 16 for obtaining report 303 information associated with the compensation included in the payment 12. At step 410, the payment module 306 generates the payment 12 for the affiliate 18 including compensation commensurate with the confirmed level of link 12 activity. At step 412, optionally the status module 307 generates the report 303 including an explanation of the links 24 activity in order to associate the compensation with specific activities of the link 24 activity. At step 414, the payment 12 and optionally the report 303 are communicated to the affiliate 18.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. A method for communicating payment to an affiliate based on electronic link activity for directing visitor traffic over a network to a company, the link activity being attributed to the affiliate, the method comprising the acts of:
receiving a request for payment for the affiliate including a specified payment period, a specified link set, and at least one company associated with the link set;
contacting the at least one company for the payment period for confirming a level of the link activity for the link set during the payment period;
generating a payment for the affiliate including compensation commensurate with the confirmed level of link activity; and
communicating the payment to the affiliate.

2. The method of claim 1 further comprising receiving payment from the at least one company for at least a portion of the confirmed level of link activity after the corresponding communication of said payment to the affiliate.

3. The method of claim 1 further comprising said compensation including a first compensation portion based on the confirmed level of link activity, such that a second compensation portion based on the confirmed level of link activity is communicated separately from said payment to the affiliate.

4. The method of claim 3, wherein the second compensation portion based on the confirmed level of link activity is communicated by the company.

5. The method of claim 1 further comprising contacting the at least one company for obtaining report information associated with said compensation included in said payment.

6. The method of claim 5, wherein the report information includes an explanation of the links activity in order to associate said compensation with specific activities of the link activity.

7. The method of claim 6, wherein the report information includes link activity metrics generated by the company.

8. The method of claim 5 further comprising generating a series of subsequent payment requests based on a specific payment frequency provided for the affiliate for the link set.

9. The method of claim 8, wherein the specific payment frequency is selected from the group comprising: said payments for an indefinite time period; said payment as a one time payment; and a recurring cycle of said payment.

10. The method of claim 1, wherein the link set specifies one or more visitor selectable connections selected from the group comprising: an Inline Text Link; a Text Banner; a Graphical Rich Media Banner; an In-page Graphical Banner; a Pop-Under object; a Pop-Up object; an XML Feed; a Layer Ad; a coupon code; a unique code; and a Search box.

11. A system for communicating payment to an affiliate based on electronic link activity for directing visitor traffic over a network to a company, the link activity being attributed to the affiliate, the system comprising:
a data collection module for receiving a request for payment for the affiliate including a specified payment period, a specified link set, and at least one company associated with the link set;
a confirmation module for contacting the at least one company for the payment period for confirming a level of the link activity for the link set during the payment period; and
a payment module for generating a payment for the affiliate including compensation commensurate with the confirmed level of link activity;
wherein the payment is communicated to the affiliate.

12. The system of claim 11 further comprising a receivables management module for receiving payment from the at least one company for at least a portion of the confirmed level of link activity after the corresponding communication of said payment to the affiliate.

13. The system of claim 11 further comprising a receivables management module configured such that said compensation includes a first compensation portion based on the confirmed level of link activity and a second compensation portion based on the confirmed level of link activity is communicated separately from said payment to the affiliate.

14. The system of claim 13, wherein the second compensation portion based on the confirmed level of link activity is communicated by the company.

15. The system of claim 11 further comprising a report module for contacting the at least one company for obtaining report information associated with said compensation included in said payment.

16. The system of claim 15, wherein the report information includes an explanation of the links activity in order to associate said compensation with specific activities of the link activity.

17. The system of claim 16, wherein the report information includes link activity metrics generated by the company.

18. The system of claim 15 further comprising the payment module configured for generating a series of subsequent payment requests based on a specific payment frequency provided for the affiliate for the link set.

19. The system of claim 18, wherein the specific payment frequency is selected from the group comprising: said payments for an indefinite time period; said payment as a one time payment; and a recurring cycle of said payment.

20. The system of claim 11, wherein the link set specifies one or more visitor selectable connections selected from the group comprising: an Inline Text Link; a Text Banner; a Graphical Rich Media Banner; an In-page Graphical Banner; a Pop-Under object; a Pop-Up object; an XML Feed; a Layer Ad; a coupon code; a unique code; and a Search box.

21. A computer program product for communicating payment to an affiliate based on electronic link activity for directing visitor traffic over a network to a company, the link activity being attributed to the affiliate, the computer program product comprising:
a computer readable medium;
a data collection module stored on the computer readable medium for receiving a request for payment for the affiliate including a specified payment period, a specified link set, and at least one company associated with the link set;
a confirmation module stored on the computer readable medium for contacting the at least one company for the payment period for confirming a level of the link activity for the link set during the payment period; and
a payment module stored on the computer readable medium for generating a payment for the affiliate including compensation commensurate with the confirmed level of link activity;
wherein the payment is communicated to the affiliate.
